(19) United States
(12) Patent Application Publication
(10) Pub. No.: US 2008/0274436 A1
(43) Pub. Date: Nov. 6, 2008

(54) Optically regulated dental light unit

(75) Inventors: John West, Arroyo Grande, CA (US); Robert L. Ibsen, Santa Maria, CA (US); Harold Hallikainen, San Luis Obispo, CA (US); Scott Ganaja, San Luis Obispo, CA (US)

Correspondence Address: CROWELL & MORING LLP;INTELLECTUAL PROPERTY GROUP, P.O. BOX 14300, WASHINGTON, DC, 20044-4300, US

(73) Assignee: Den-Mat Corporation, Santa Maria, CA (US)

(21) Appl. No.: 11/797,629

(22) Filed: May 4, 2007

(51) Int. Cl. A61C 3/00

(52) U.S. Cl. 433/29

(57) ABSTRACT

A dental system includes a light source, a power supply that adjusts a quantity of light produced by the light source, a measuring device that measures a quantity of light received from the light source, an input, through which user data, including a desired quantity of light, can be entered, and a controller which, together with the measuring device, forms at least part of a feedback loop. The controller receives the user data and communicates with the measuring device and the power supply so that the power supply adjusts a quantity of light emitted by the light source. As a result, the quantity of light received from the light source becomes substantially equal to the desired quantity of light.

### BACKGROUND OF THE INVENTION

1. Field of the Invention

The present invention relates to dental light curing systems and methods for using such systems, as well as to systems and methods for light regulation useful in applications other than curing dental resins.

2. Description of Related Art

Light curable composite resins have been an important part of dentistry for over 20 years. These resins are commonly used for preparing restorations, cementation of restorations, and a number of other dental restorative procedures such that light curing is now a standard procedure in dentistry.

These light curable resins used by dentists for tooth restoration and repair require a light cure unit to initiate polymerization. Initial curing lights consisted of halogen devices, first with light sources removed from the point of application and thereafter with light transmitted to the point of application through long fibers. Following that, light curing guns were introduced. These devices typically used halogen light sources with short fused fiber optic light guides close to the lamp to apply high intensity light at the point of application.

Different light cure units vary in their abilities to polymerize the resin. This occurs for a variety of reasons including but not limited to power density (mW/cm²), wavelength (nm), geometry of light as it exits the light guide, and distance to the resin.

In general, the greater the power density of wavelengths matched with absorptive regions of photo-initiators used in dental resins, the faster and more complete the polymerization of those resins. A decrease in power density or incompatible wavelengths can result in incomplete polymerization that can have a negative effect on the quality of a dental restoration. The effects of incomplete polymerization may include patient sensitivity, an increase in secondary caries, a reduction in wear, allergic reactions, toxicity, and other restoration failures.

All light sources have the potential of degrading for a variety of electronic, electromechanical, and mechanical reasons. Light output from lamps and LED's decrease with use. Other factors contributing to a reduction of light output include misalignment of components in the optical path, cracks, chips, and contamination of light guides, defective control electronics, and deterioration of filter coatings.

Halogen curing lights, in particular, suffer from a wide variety of mechanisms that cause degradation of intensity. This is due in a large part to substantial generation of heat that causes a degradation of the components of the curing unit over time. These mechanisms include loss of light output from the halogen lamp, filter degradation, buildup of resin on light guides, degradation of light guides due to sterilization, and faulty voltage control circuitry. A study by Barghi and colleagues found that 45 percent of light-curing units in 122 dental offices had outputs below 300 mW/cm². Even when light output is set to 300 mW/cm², a study by Fan and colleagues found that only 62 percent of the resin-based composites tested were adequately cured, with a light intensity of 300 mW/cm² in the 400- to 515-nm-wavelength range, using the manufacturer's recommended irradiation times.

A recent study empirically determined that degradation of light curing units is a real problem. The study accessed the light outputs of 214 quartz tungsten-halogen (QTH) light polymerization units in 100 different dental offices. The study concluded that light intensity values varied significantly among the units and that a unit's age and service history substantially affected its intensity output. Many of the units exhibited intensity values well below the recommended levels. The study concluded that dentists need to regularly monitor the intensity of their light curing units and maintain the units. A failure to do so could result in providing patients with composite restorations with inferior properties. See Avedis Encioiu et al, Intensity of quartz-tungsten-halogen light-curing units used in private practice in Toronto, J. Am. Dent. Assoc., 2005 June; 136 (6):766-73.

Dental radiometers were developed to measure the actual output of light from a light curing unit as a means of assessing the curing light's ability to properly polymerize dental restorative materials. However, it has been found that dentists do not consistently use radiometers to measure curing lights before use.

Common radiometers in dentistry use either silicon or selenium detector cells with filters that block energy outside of the 400-500 nanometer range. Initially, radiometers were developed specifically for use with halogen light sources with their filters matched fairly closely to the wavelength distribution of the curing lights themselves. In recent years, other types of light sources have been introduced, namely plasma arc or gas pressure lamp devices, using xenon lamps to produce high intensity light in the 400-500 nanometer range. More recently, light emitting diodes (LED's) have been used to produce light specifically peaking at around 470, 450, 420, 400 and below nanometers so as to match the absorption characteristics of photo-initiators currently used in dentistry to polymerize these restorative materials. However, when one uses a different light source on the same radiometer designed for halogen usage, erroneous readings result. Accordingly, radiometers must typically be calibrated for use relative to a given light source. The National Institute of Standards and Technology (NIST) presently requires every radiometer to be designed specifically for the light source with which it is to be used.

It has been proposed that manufacturers of dental resins label those products with the required wavelength(s) and total energy per unit area required for polymerization. An example of this is provided by BISCO, Inc. which recommends using a conventional halogen curing light that produces a full spectrum (400-500 nanometer) wavelength in order to polymerize BISCO's ELITE LS Packable composites. Using such a light, BISCO recommends placing 1-2 mm increments of composite into cavity preparation and building the restoration incrementally. Each increment is then to be light-cured for 20 seconds at 500 mW/cm² (10.0 J/cm²) and filled to the cavosurface margin. The final increment should be light-cured for 30 seconds (15.0 J/cm²).

BISCO also describes a method for calculating a curing time for its BISCOVER liquid polish product. BISCO determines the minimum amount of energy per unit area required to achieve clinically acceptable polymerization of its BISCOVER product. BISCO describes this amount of energy per unit area as the energy of optimization of polymerization (EOP). BISCO determines the EOP using a calibrated quartz tungsten halogen curing light to a cure a BISCOVER sample in the laboratory. The degree of polymerization of the cured BISCOVER is then measured spectroscopically in the laboratory. The EOP corresponds to the minimum amount of energy per unit area needed to achieve a clinically acceptable degree of polymerization as measured by the spectroscope. BISCO provides the EOP value in its instruction manual for BISCOVER, and instructs the user to determine the power density of their curing light using a radiometer. The curing time for the BISCOVER can then be calculated by dividing the EOP by the determined power density.

BISCO also markets a light curing unit that can aid in this curing time calculation. BISCO's VIP dental curing unit includes a built in radiometer. A user can calibrate the VIP unit by first selecting a desired intensity and then placing the probe tip of the VIP unit over the radiometer sensor included on the unit. The unit measures the intensity of light actually emitted from the probe tip and compares it to the selected desired intensity. The unit then adjusts the output of the light source until the measured intensity is equal to the desired intensity.

Whether using a separate radiometer to determine the actual intensity of a light source or using the built in radiometer on the BISCO VIP unit, a user of known light curing units must first perform a separate step of measuring the intensity of light source in order to determine the desired curing time of a light curable material. This separate step must be performed before the user performs the actual light curing process. Therefore, there remains a need in the dental arts for a light curing unit that automatically adjusts the intensity of the light source in real time in order to provide an actual intensity of light substantially equal to a user desired intensity of light without requiring the user to perform a separate step.

The technology in dental and other light sources may not be halogen-based. Light-emitting diodes (LEDs) are currently being designed into dental and other light sources since LEDs, LED arrays, LED dies, and so on do not exhibit the same degradation profiles with relatively few hours of use as halogen lamps. If designed for use within specified operating parameters, LEDs last for tens of thousands of hours, and output does not diminish significantly over time. In dental and other applications, however, LEDs may be overdriven, or driven with excessive current, and under-cooled. This does result in degradation and a loss of light output. Regulated light sources are important for extending the lives of LED-based designs, especially as light output from LEDs increases, so that the LEDs can be under-driven. In the future, therefore, as LED technology improves, LEDs will become brighter, and regulation will be used to drive the LEDs at lower current ratings initially and then at higher current ratings as light output degrades to keep the light output stable. LEDs are typically being driven at maximum electrical ratings or overdriven to achieve desired light outputs. As future LEDs produce greater amounts of light, there will be an increased need for optical regulation of LED output.

LEDs have gained popularity for use in dental light systems, as noted. The latest generation of LEDs typically has increased life and stability over their halogen counterparts. However, light degradation caused by excessive temperature and drive currents is a recognized problem. In addition, there are wide variations in the total power or light output among individual devices within the same manufacturers' grouping code.

Optical regulation is important in dental and other light systems that use LEDs as light sources, particularly if means are provided to measure actual light output for repeatability instead of just depending on a constant drive current to produce the same light levels each time. Optical regulation also provides a way to compensate for differences in light output between LED devices, especially where some produce greater light than others. The drive current can thus be regulated down to achieve the desired light output while reducing heat in the LED and extending life.

Optical regulation additionally provides a way to produce the same light levels at all times by measurement of actual light output at an end of the optical path close to where the light exits the light system rather than just depending on a constant drive current to produce the same light levels each time.

Phillips Lumileds is one manufacturer of LED devices currently used in dental light systems. The Lumileds Luxeon Reliability Datasheet RD25 points to requirements for a customer to adhere to the device thermal design parameters, maximum electrical ratings, and assembly practices. The RD25 Datasheet states that LEDs experience a gradual permanent reduction in light output during operation. This phenomenon, it is noted, is called light output degradation, or lumen maintenance, and can either be caused by a reduction in the light generating efficiency of the LED die or a reduction in the light transmission of the optical path within the LED package. The lumen maintenance is a function of drive current, with a higher drive current causing a higher rate of light degradation. Lumen maintenance is worse at higher junction temperatures. Operation at junction temperatures above the maximum rating can cause lens-yellowing or delamination inside the package, which can result in a permanent reduction in light output.

Designers and manufacturers of dental and other light systems that use LEDs as light sources are instructed that constant current electrical drivers are required to regulate current through the LEDs regardless of power supply (voltage) variations or changes in forward voltage drops (VF) between LEDs. Selection of the LED drive current may be based on consideration of the maximum electrical and temperature ratings of the device and the desired amount of light to be emitted by the light system. Light output from a LED is proportional to the current passing through the device, which can be very high in dental light systems. Light output reduces as a LED heats up, and lifetime is degraded. Because of this, careful thermal management is required.

### SUMMARY OF THE INVENTION

One object of the present invention is to provide stable and repeatable light output from a dental or other light system.

Another object of this invention is to provide a system capable of working in combination with electrical and thermal management systems to optimize LED performance and life.

It is a further object of this invention to compensate for variations in light output among individual LED devices.

Yet another object of the invention is to use optical regulation to limit LED electrical drive current to a minimum current required to achieve stable and repeatable desired light output from a dental light system.

These and other objects are achieved by way of the present invention, which provides real time light measurements with each use and alerts the user if a desired quantity of light is not supplied. One dental system according to the present invention is a light curing system that includes a light source, a power supply that adjusts a quantity of light produced by the light source, a measuring device that measures a quantity of light received from the light source, an input, through which user data, including a desired quantity of light, can be entered by a user, and a controller that, together with the measuring device, forms at least part of a feedback loop. The controller communicates with the power supply and the measuring device and receives the user data in order to cause the power supply to adjust a quantity of light emitted by the light source so that the quantity of light received from the light source becomes substantially equal to the desired quantity of light. It is to be understood that in the context of the invention, the “quantity of light” or “light quantity” referred to encompasses but is not limited to light quantities determined by measurement of intensity, irradiance, or power density (e.g. mW/cm²), energy density (e.g. mJ/cm²), total power (e.g. mW), or in any other practical manner.

The measuring device can be disposed in a light transmission path, and may also be either the only measuring device or one of a plurality of measuring devices disposed in a light transmission path. Examples of appropriate measuring devices are photodiodes, photodetectors, phototransistors, photoresistors, light-to-analog light sensors, light-to-digital light sensors, light-to-frequency light sensors, and combinations thereof. More than one measuring device could be provided.

The light source could be any of a halogen light source, a xenon light source, a LED light source, a LED emitter light source, a LED die light source, a LED array light source, a metal halide light source, a mercury vapor light source, a sodium light source, and a laser light source, and more than one light source could be utilized.

The system could further include a curing unit that is held by hand during curing procedures, a light guide with one or more light transmitting element or elements including single or multiple clad or unclad optical conductors providing light transmission from the light source to the hand held curing unit, and a housing, containing at least the light source, adapted to receive an end of the light guide. Some of the light transmitting elements could be bifurcated into a separate bundle leading to the measuring device.

As an alternative to using a light guide and a light source contained in a separate housing, or in addition to such a use, the hand held curing unit could include a lens or cover assembly disposed at a distal end of the hand held curing unit; such a lens or cover assembly could be disposed at a distal side of the light source, for example.

The light source, the controller, or both may be powered by alternating current or direct current, and the overall system could be configured to fit in a user's hand during operation, if desired. The system could be cordless, and the light source, the controller, or both may be powered by direct current or attached to an alternating current/direct current or direct current/alternating current converter.

The controller includes at least one microprocessor, microcontroller, or other control device adapted to receive input from the light measuring device, perform a comparison of the input received from the light measuring device and a set point, and adjust the quantity of light supplied by the light source based on the comparison. Such adjustment could be by current or voltage regulation. A radiometer permitting the user to manually verify proper operation of the system can also be provided.

According to the invention, processes of curing a composite dental resin using a real time, optically regulated light curing unit and of compensating for effects on how such a unit is held by a user are additionally contemplated. Such processes could include acts or operations such as supplying light by way of a light source to the resin, receiving data, including data representing a desired light quantity, entered by a user, measuring a light quantity received from the light source, performing a comparison of the desired light quantity with the measured light quantity, and adjusting the light quantity produced by the light source based on the comparison.

### BRIEF DESCRIPTION OF THE DRAWINGS

FIG. 1 is a graph illustrating a reduction of light output as a function of time for three different lamps.

FIG. 2 is a graph illustrating irradiance as a function of wavelength for three different lamps when the light source has a low set point.

FIG. 3 is a graph similar to that of FIG. 2 but when the light source has a high set point.

FIGS. 4A-4H together illustrate a table showing full-spectrum data represented in FIGS. 2 and 3.

FIG. 5 is a graph illustrating the effect of distance on irradiance.

FIG. 6 illustrates the construction of one light guide embodiment.

FIG. 7 shows a hand held curing unit and a light source housing of an overall light curing unit

FIG. 8 is a view of the interior of a hand held light curing unit with part of the light guide of FIG. 6 mounted therein.

FIG. 9 is a view similar to that of FIG. 8 but showing an alternate light guide embodiment.

FIG. 10 shows placement of a light regulation sensor assembly in the configuration of FIG. 9.

FIG. 11 illustrates another embodiment of the hand held light curing unit having a light transmitting lens or cover member placed at the distal end of the unit and a light regulation sensor assembly placed near the lens or cover member.

FIG. 12 is a view of the interior of a hand held light curing unit with a light regulation sensor assembly placed in proximity to a light source and on the proximal side of the light transmitting lens or cover member.

FIG. 13 is a view similar to that of FIG. 12 but showing the light regulation sensor assembly on the distal side of the lens or cover member.

FIG. 14 is a dual channel oscilloscope reading of light regulation sensor assembly output and curing light output in which parallel channel signals show successful light regulation.

FIG. 15 is a block diagram schematically showing elements of the overall light system of the invention.

### DETAILED DESCRIPTION OF THE INVENTION

For simplicity and illustrative purposes, the principles of operation of the present invention are now described. Although certain embodiments of the invention are particularly described, one of ordinary skill in the art will readily recognize that the same principles are equally applicable to, and can be implicated in, other devices and methods, and that any such variation would be within such modifications that do not part from the scope of the present invention. It is to be understood that the invention is not limited in its application to the details of any particular embodiment shown, since of course the invention is capable of other embodiments. The terminology used herein is for the purpose of description and not of limitation. Further, although certain methods are described with reference to certain acts, operations, or steps that are presented herein in certain order, in many instances, these acts, operations, or steps may be performed in any order as may be appreciated by one skilled in the art, and the methods are not limited to the particular arrangement of steps disclosed herein. Although certain embodiments are shown in the figures, moreover, the present invention is certainly not intended to be limited to these portrayed embodiments.

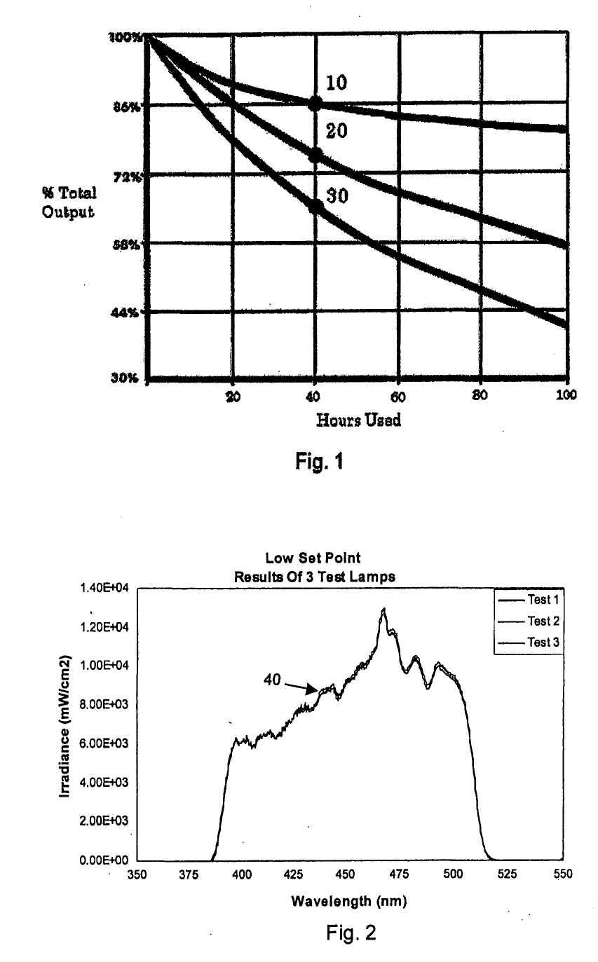

FIG. 1 illustrates the reduction of light output as hours used increases and how the percentage of total light output for three different lamps, 10, 20, and 30 is different even though each lamp has been used for the same number of hours.

FIG. 2 illustrates the real time optical regulation of three lamps with different outputs placed in the same light source with a low set point. The irradiance plots 40 overlap each other, which indicates that the lamps are regulated to the same output.

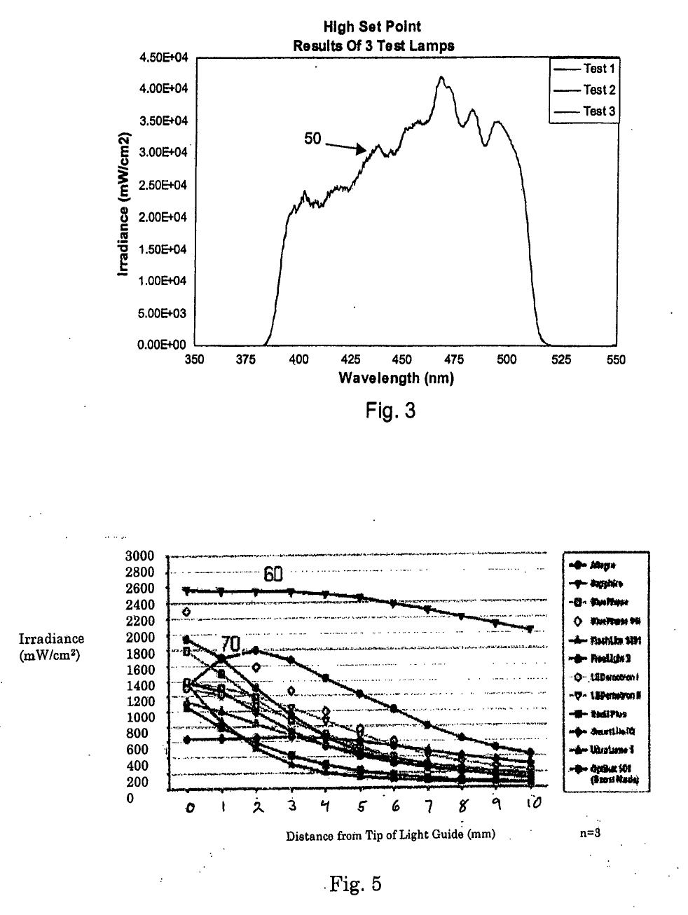

FIG. 3 illustrates the real time optical regulation of three lamps with different outputs placed in the same light source with a high set point. The irradiance plots 50 overlap each other, which indicates that the lamps are regulated to the same output.

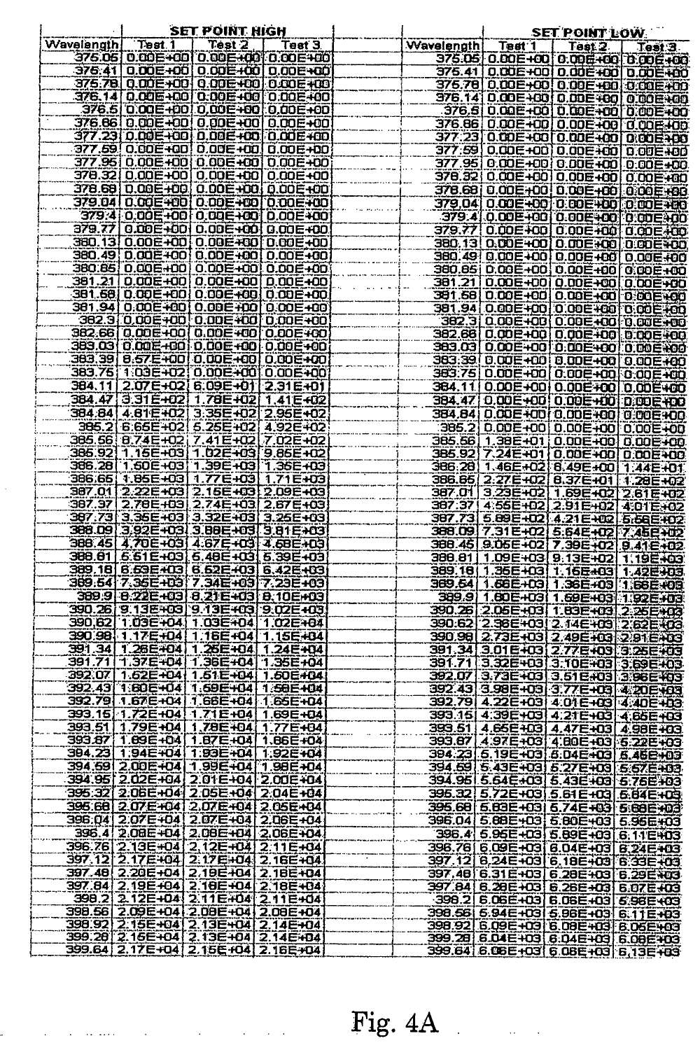

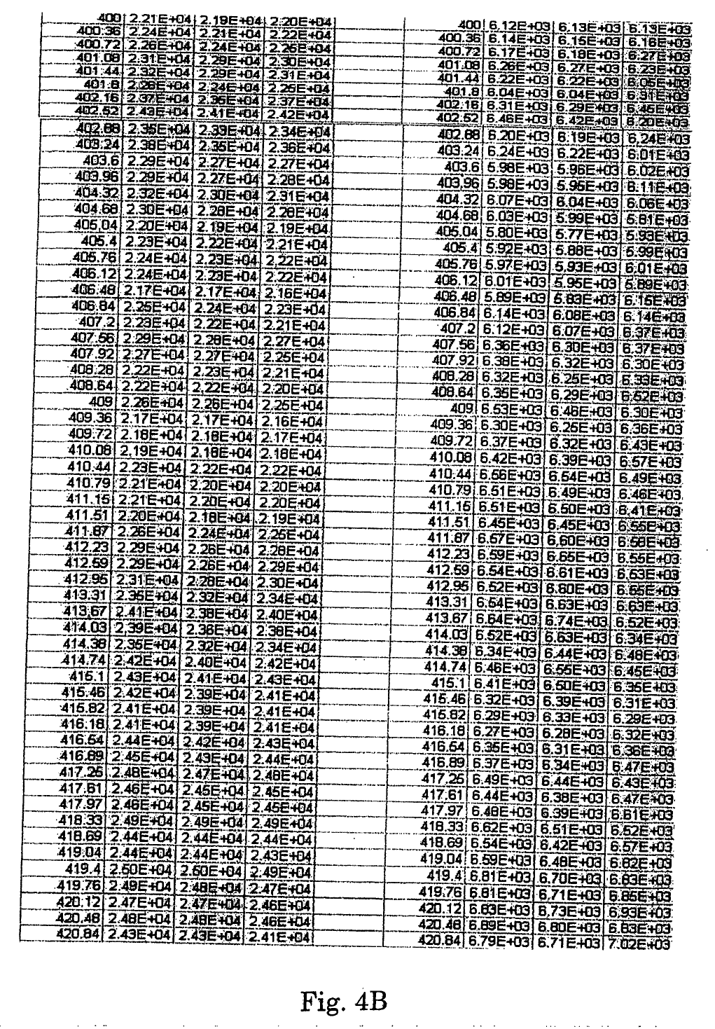

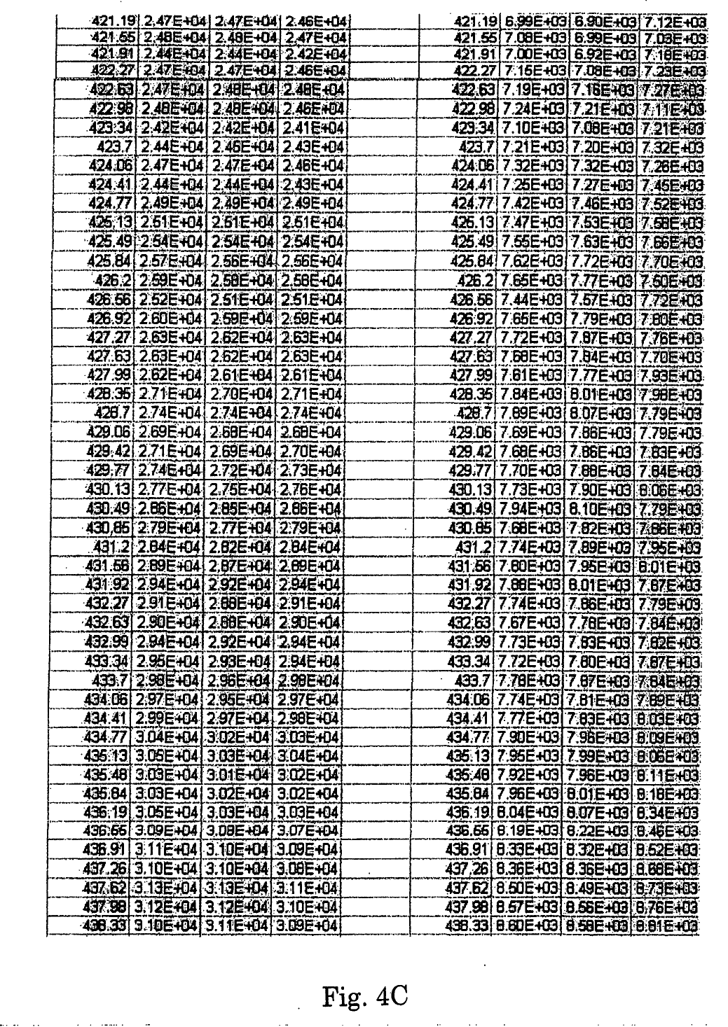

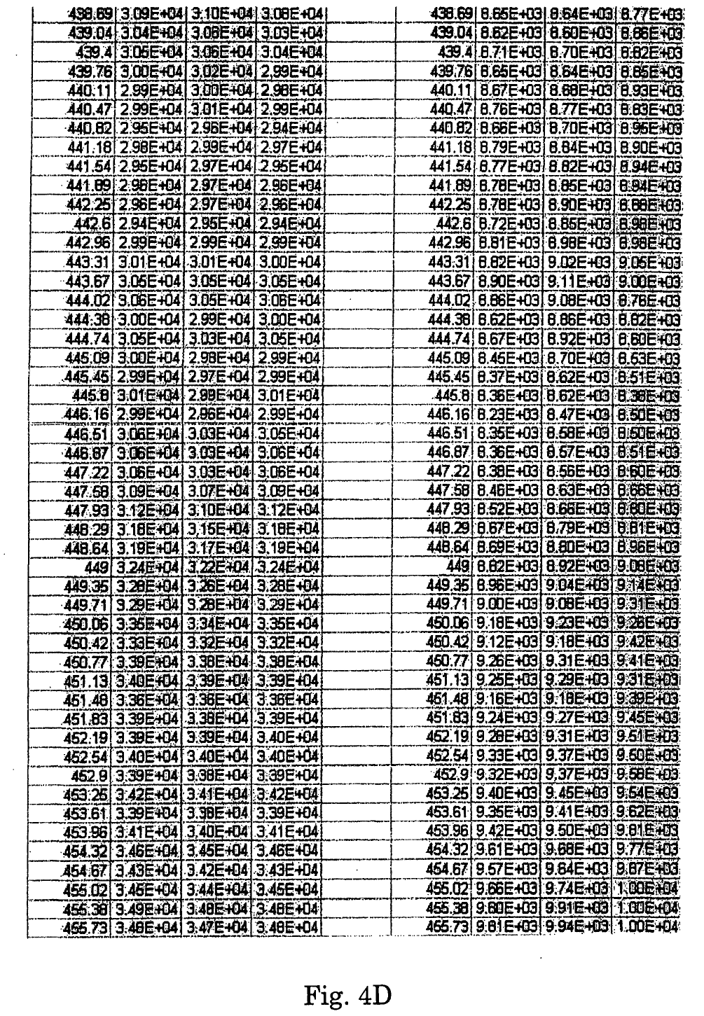

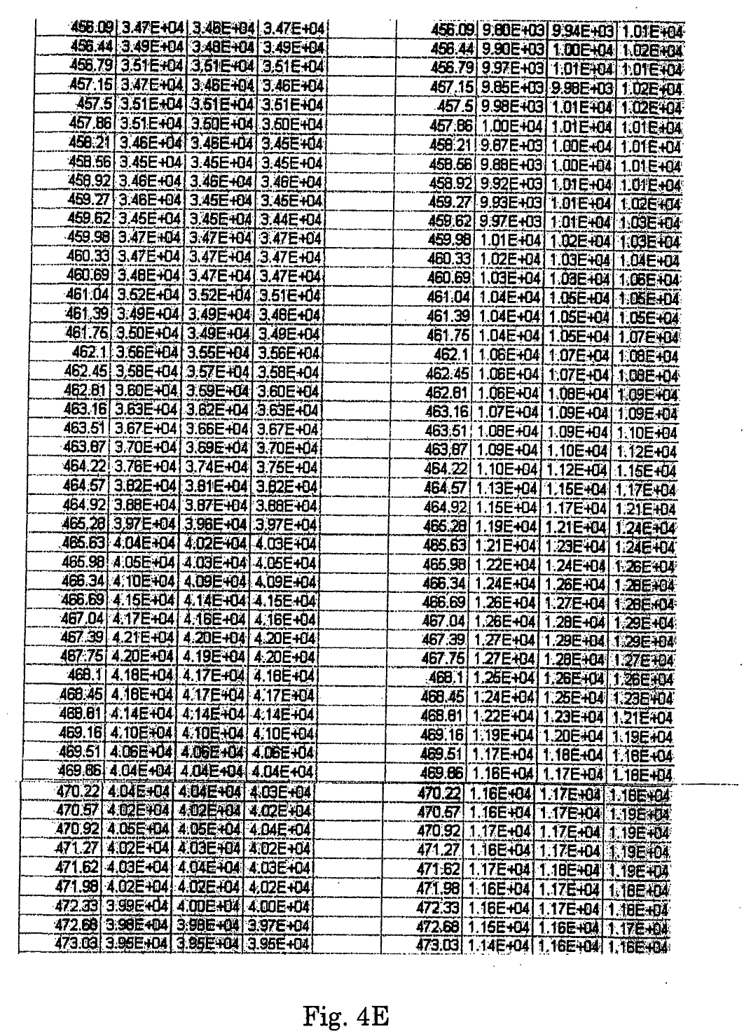

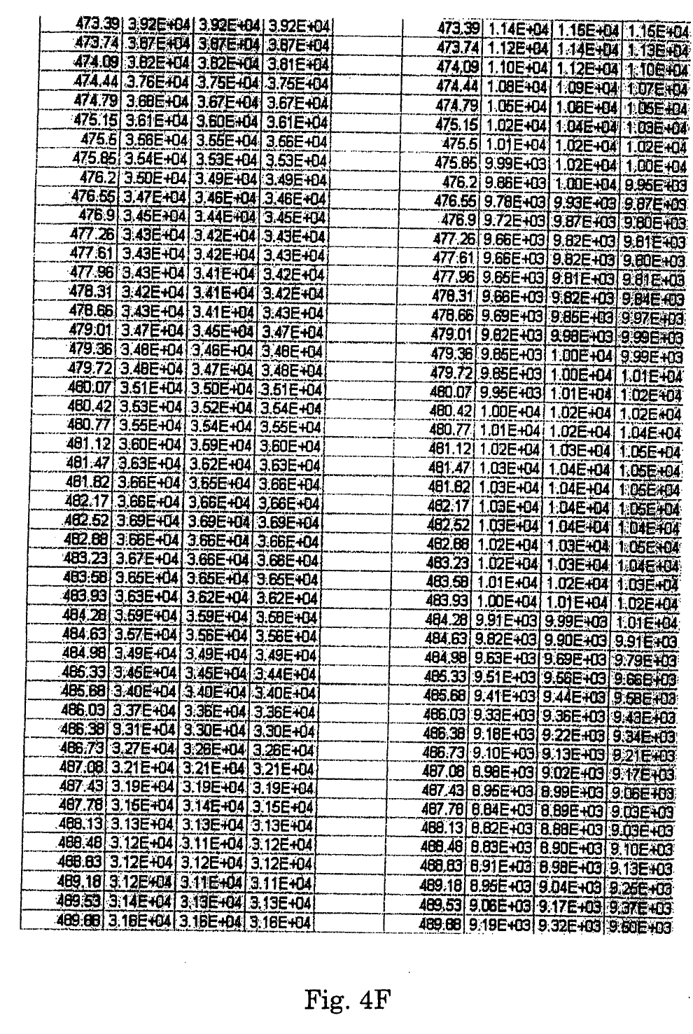

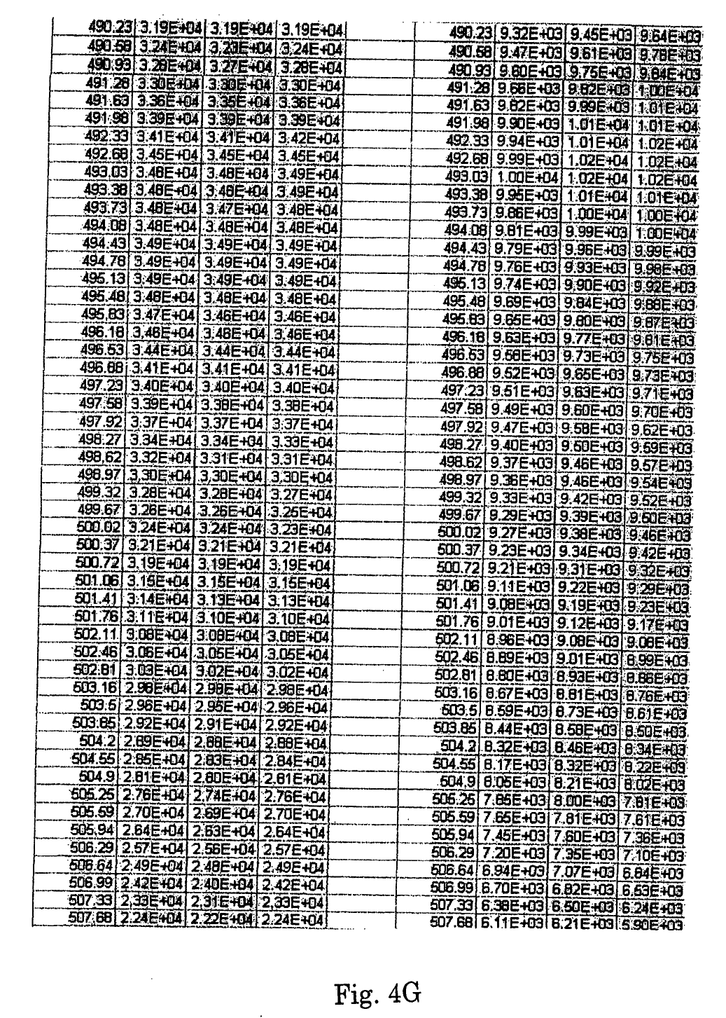

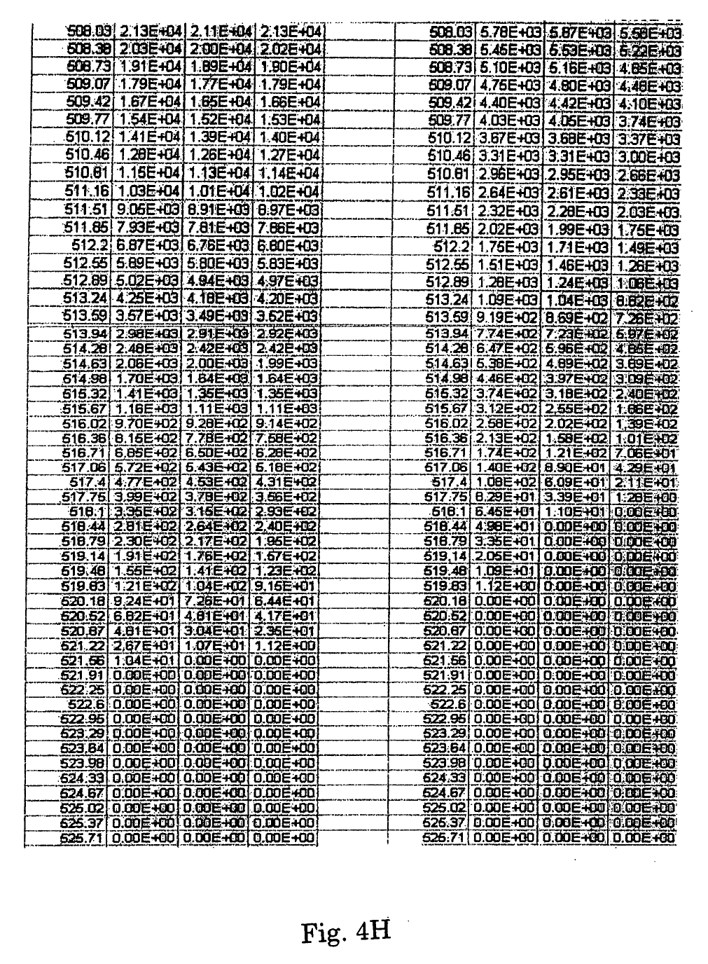

FIGS. 4A-4H are tables showing data for the three lamps with a high set point and low set point. Three different lamps, each producing different total output power, were placed in the same light source with no additional changes. The data show the output values for all three lamps, Test 1, Test 2, and Test 3, to be very similar. This indicates that the real time optical regulation is working.

FIG. 5 illustrates the effect of distance on irradiance. As distance increases irradiance decreases. The irradiance decrease of light source 60 is less than that of the light source 70. As irradiance decreases with distance, regulation provided by the curing unit could be used to increase curing unit output and vice versa, although irradiance at a given location is affected by how a hand held curing unit, to be described, is held by a user.

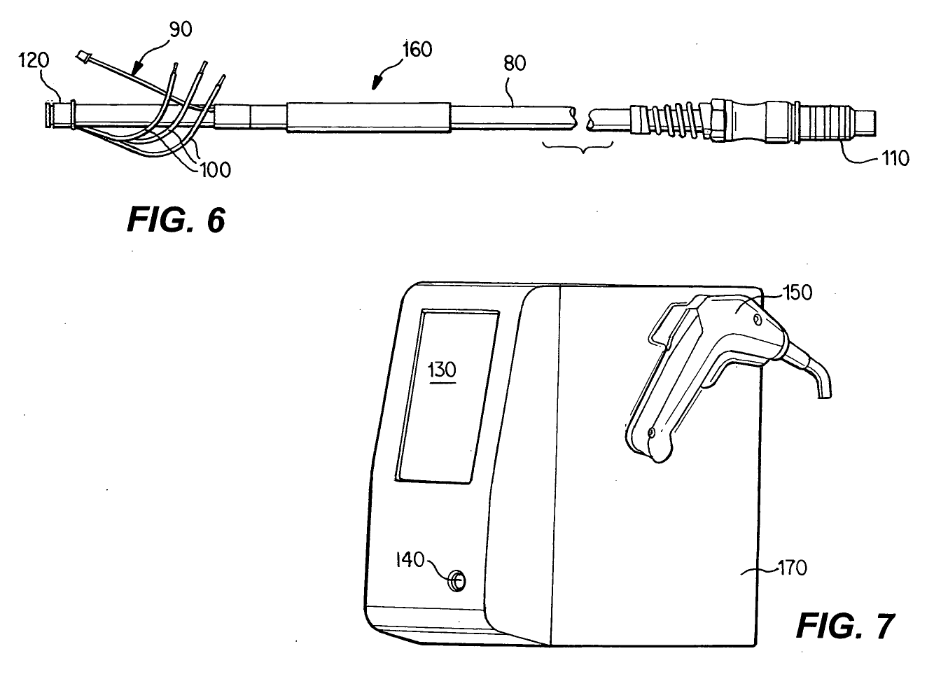

FIG. 6 illustrates a flexible light guide construction. The light guide 160 includes individual fiber optic strands, randomized and bundled together inside of a protective covering 80. Light enters the proximal end 110 of the light guide and exits at the distal end 120 of the light guide. The proximal end 110 is positioned inside a light source housing 170 such as that shown in FIG. 7, containing a light-generating source such as one of the light sources referred to above or discussed below (not shown in FIG. 6), in proximity to a focal point of the appropriate light source. The proximal end 110 further has electrical connections, such as the electrical contacts represented in FIG. 6 by three rings extending circumferentially around the proximal end 110. The electrical connections mentioned could take other forms, such as contact terminals, hard wired connections, or other arrangements providing electrical continuity. The electrical connections at the proximal end 110 define ends of power and communication paths (not represented in FIG. 6) between the proximal end 110 and wires 100 at the distal end 120. The wires 100 interconnect control electronics in the hand held curing unit 150, shown in FIG. 7, and the light source housing 170, also shown in FIG. 7. In the light guide embodiment shown in FIG. 6, a portion of the individual fiber optic strands is bifurcated into a separate fiber bundle 90. In one configuration such as that shown in FIG. 7, the hand held curing unit 150, coupled to the light source housing 170 by the light guide 160 (not shown in FIG. 7), can be placed in proximity to a radiometer assembly window or input 140 to measure a characteristic of light quantity, such as power density (mW/cm²), provided by the hand held curing unit 150.

The hand held curing unit 150, the flexible light guide 160, and the light source housing 170, along with electronics associated therewith, combine to form an overall light curing unit. FIG. 7 illustrates an embodiment of the hand held light curing unit 150 and the light source housing 170 with a light guide similar to the light guide 160 removed. The distal end 120 of a flexible light guide, similar to the guide 160 shown in FIG. 6, is attachable to the hand held curing unit 150 shown in FIG. 7, while the proximal end 110 of the light guide is receivable in an appropriate receptacle defined in the housing 170 of the overall light curing unit. A display 130 provides a means to communicate the effect of real time light regulation on the light quantity output to the user, and may also be used for data input. A graphic LCD display is contemplated, but the display could also consist of or include an analog dial, a digital display, or any of LED, OLED, vacuum fluorescent, plasma, CRT, and incandescent displays, or other graphic or alpha-numeric displays. The radiometer assembly window or input 140, which receives light output from the hand held curing unit 150, allows the user to check the final light quantity from the distal end of the curing probe contained in the hand held curing unit 150. An alternate embodiment of the hand held curing unit 150 and light source is a battery operated hand held curing unit that does not include an integral light guide 160. In this case, a light generating source such as one of those previously referred to above or discussed below (not shown) is contained within the hand held curing unit 150.

FIG. 8 shows a portion of the flexible light guide 160 of FIG. 6 assembled in a particular embodiment of the hand held curing unit 150. The fiber optic strand bundle 90 here is attached to a light quantity sensor assembly 200. The proximal end 110 (FIG. 6) of the flexible light guide 160 is placed in proximity to the light source. Light enters the proximal end of the flexible light guide and travels toward the distal end. The separate fiber bundle 90 is split off from the main bundle and directed to the light quantity sensor assembly 200. Light received by the light quantity sensor assembly 200 is representative of total amount of light being transmitted from the light source through the main fiber bundle contained in the flexible light guide 160.

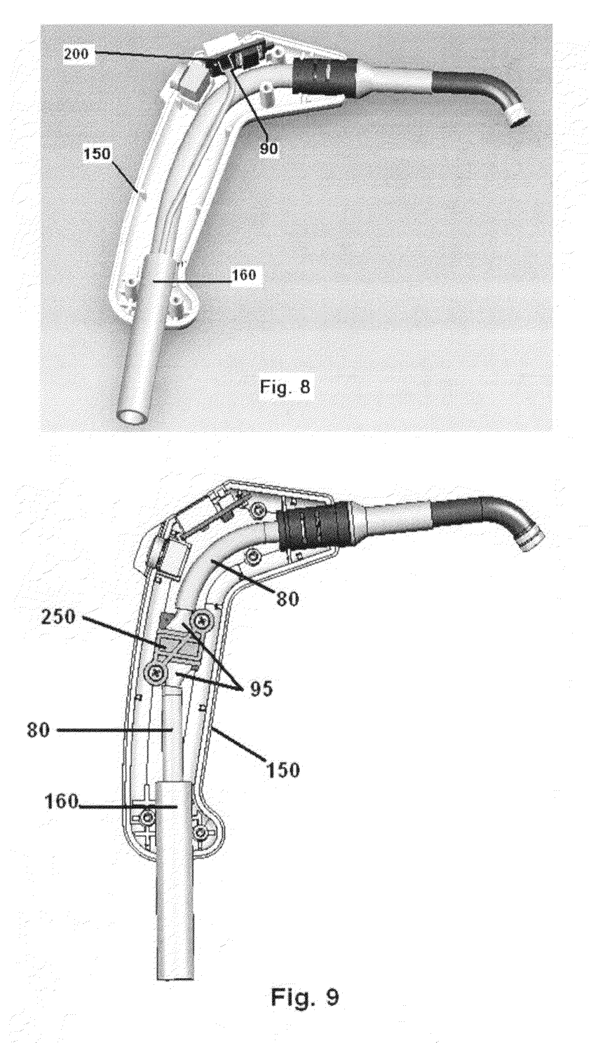

FIG. 9 shows an alternate construction by which to optically sense a light quantity proportional to the total amount of light transmitted from the light source through the main fiber bundle 95 contained in the flexible light guide 160. The light quantity sensor assembly 250 in this construction is placed over and around the whole or a portion of the optical fibers contained within the flexible light guide 160 that are bare and exposed between sections of the covering 80. As light escapes through the sides of the optical fibers, it is detected by the light quantity sensor assembly 250. The light quantity sensor assembly 250 may be used in place of an assembly 200 as shown in FIG. 8, and permits the use of a light guide without a separate fiber bundle 90 if so desired.

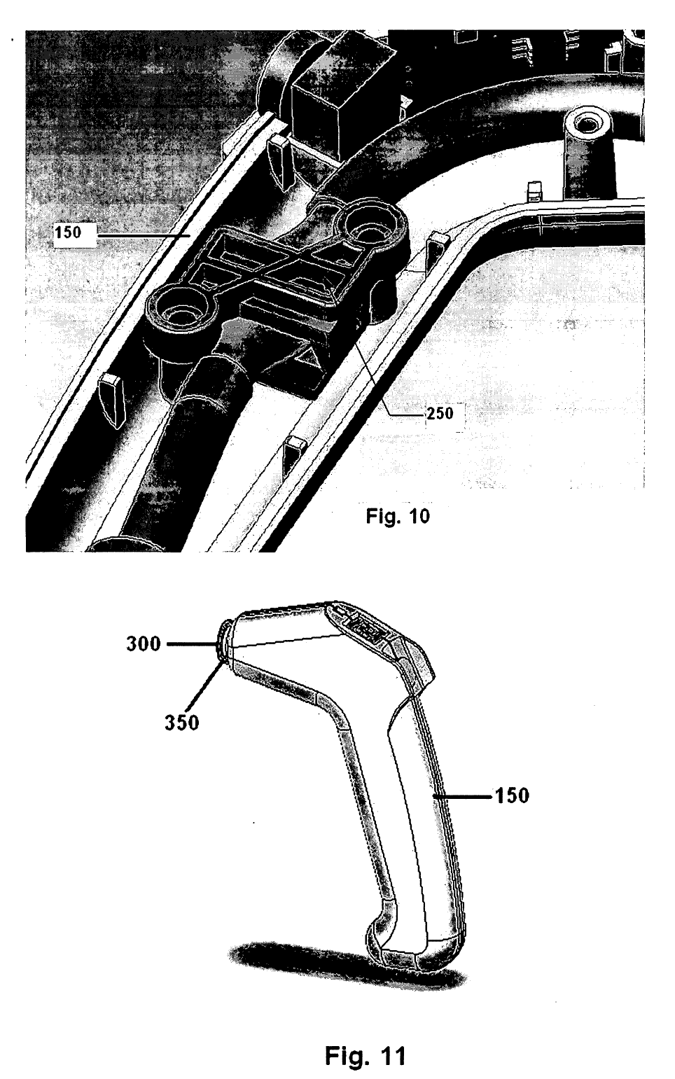

FIG. 10 is an enlarged view of the bare optical fibers placed within the light quantity sensor assembly 250. The assembly 250 is constructed in such a way that its sensor is or sensors are uniformly illuminated, so that the total amount of light being transmitted from the light source through the fibers contained within the flexible light guide is accurately represented, regardless of placement position of the light guide within the light source.

FIG. 11 illustrates another embodiment of the hand held curing unit 150 with a lens or cover assembly 350 on the distal end of the hand piece. The light source is placed in proximity to the lens or cover assembly so that light is transmitted forward through the lens or cover assembly to the target without the use of a light guide or other such additional light transmitting member. When a lens is utilized, it may be used to focus the light from the light source. The lens or cover assembly 350 may be used to prevent the light source from becoming contaminated, and may also prevent the light source and support materials from coming in contact with the target or adjacent matter. A light quantity sensor assembly 300 may also be included. The light quantity sensor assembly may be integral to the lens or cover assembly as shown in FIG. 11 or placed close to the distal side of the light source and proximal of the lens or cover assembly.

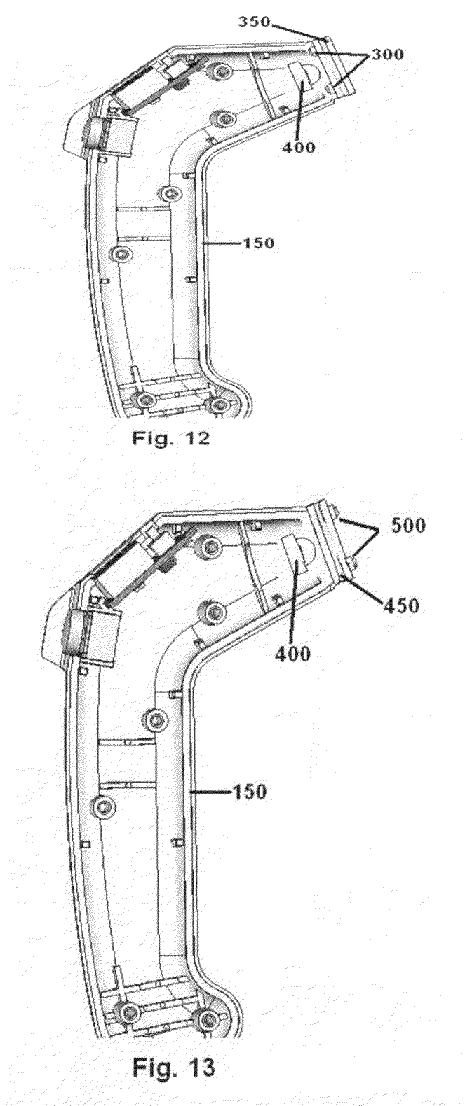

FIG. 12 shows the interior of a hand held curing unit 150 similar to that of FIG. 11 with a light source 400 placed near the distal end of the curing unit. The light quantity sensor assembly 300 here is placed at the proximal side of the lens or cover assembly 350 and at the distal side of the light source 400. Light is received by the light quantity sensor assembly 300 as it exits the light source 400 and before it enters the light transmitting lens or cover assembly 350. Light regulation therefore occurs based on input received prior to light traveling through the lens or cover assembly 350.

FIG. 13 shows the interior of another embodiment of the hand held curing unit 150, quite similar to that shown in FIG. 11, with a light source 400 placed near the distal end of the curing unit. Light enters the proximal side of a lens or cover assembly 450 and travels through this light transmitting member before exiting the distal side. A light quantity sensor assembly 500 is placed at the distal side of the lens or cover assembly 450 and detects light at the distal side of this light transmitting member.

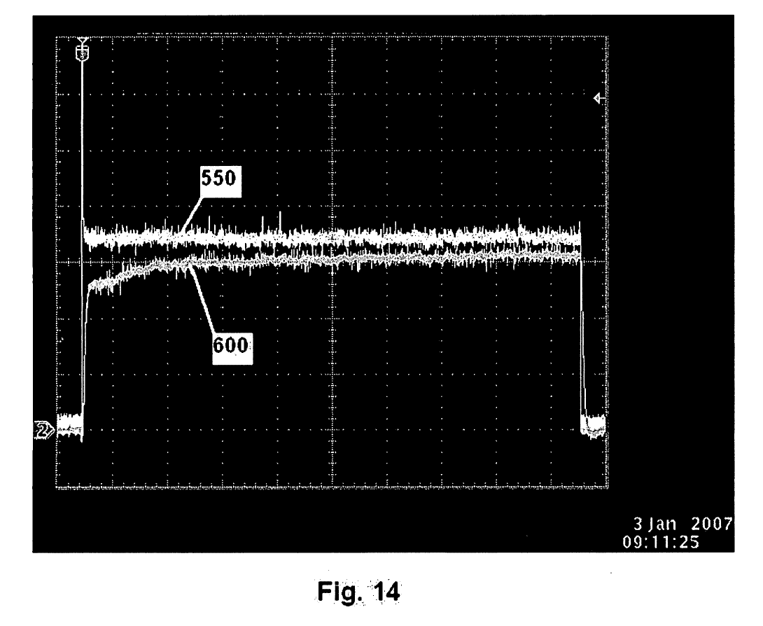

FIG. 14 is a dual channel oscilloscope image of a light curing unit with optical regulation. Output 550 from a light quantity sensor assembly such as any of the assemblies 200, 250, 300, or 500, is parallel with the light quantity output 600 from the hand held light curing unit. Parallel outputs across the time period represented by the oscilloscope traces demonstrate that the regulation circuit is working.

In a general sense, the present invention is a dental light system that includes an electromagnetic radiation generating source, such as a light source enclosed in a housing, an electromagnetic radiation transmitting member, such as the flexible light guide, a feedback control loop, the housing mentioned, a display, storage means, and an input means. Electromagnetic radiation is referred to as “light,” but it is to be understood that the electromagnetic radiation is not to be limited to any specific wavelength.

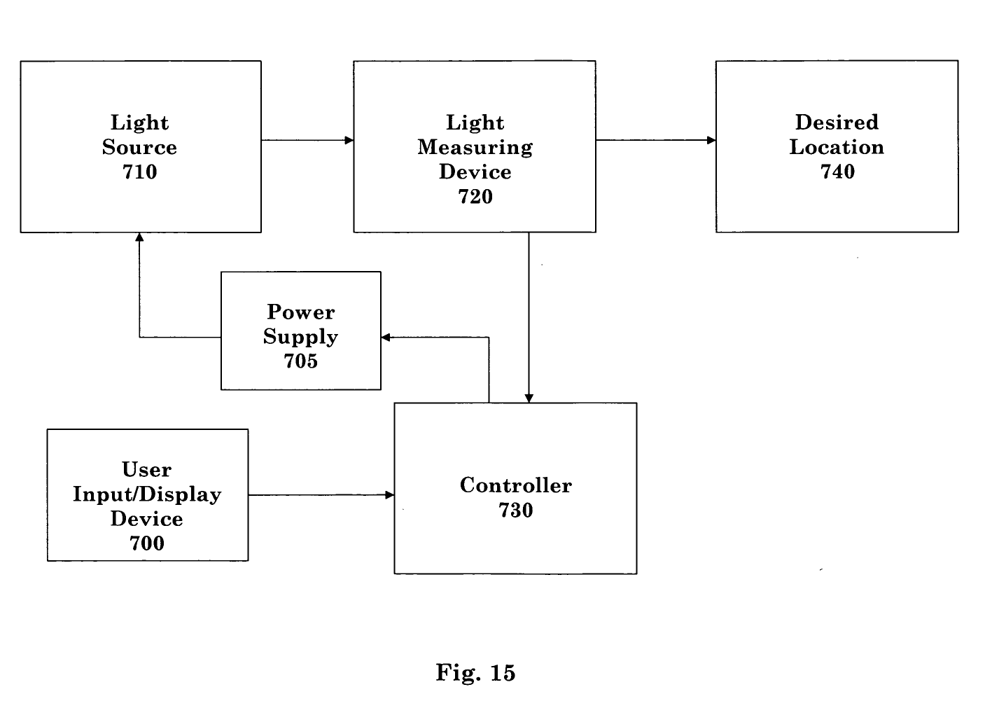

FIG. 15 schematically illustrates components of an overall dental light system, such as a curing system, according to the invention. A user is able to input data into the system, and, optionally, receive information from the system as well, by way of a user input/display device 700. The user input/display device 700 may comprise any device that allows a user to input data such as a desired quantity of light to be emitted. In one embodiment of the present invention, the user input/display device 700 could be a touch screen. Touch screens are well known in the art of dental systems and other arts and therefore an extensive description is not included here. The user may select from a number of light quantities included in a list, or the user can enter a desired quantity of light. The light quantity entered is then stored in a storage means as the quantity set point. The storage means may form a part of the user input/display device, or may form part of another element, if desired. The user input/display device 700 preferably allows a user to input particular settings, such as curing time, intensity of light emitted, total amount of energy emitted per unit area and so on.

The light source 710 may comprise one or more devices, such as the light source 400 of FIGS. 12 and 13, usable to generate light in dental light curing units, for example. Exemplary devices include halogen, xenon, LED, LED emitters, LED dies, LED arrays, metal halide, mercury vapor, sodium, and laser light sources. Of course a combination of light sources can also be used. In one preferred embodiment, the light source 710 is a xenon arc lamp.

The light transmitting member can be any device, such as the light guide 160, that can be used to transmit light in the light curing unit. Exemplary devices include flexible single or multiple clad or unclad optical fibers made of glass or plastic; waveguides and articulated arms made of metal or plastic; rigid probes consisting of single or multiple glass; plastic clad and unclad optical fibers; and hollow probes made of metal, glass, or plastic. As described above, in one embodiment, the light transmitting member is a fiber optic light guide, which may include a fiber optic bundle of individual optical fibers arranged in a randomized, blended pattern. In this embodiment, the fibers are braided along the length of the light guide. This design results in the individual fibers randomly dispersing light from adjacent fibers from the proximal end of the light guide to the distal end. Thus, if a small spot of light is directed to the distal end of the fiber optic bundle near the perimeter of the bundle, the light will travel through the optical fibers and result in a dispersed pattern of light being transmitted from the distal end of the light guide. In another embodiment, the light transmitting member could be a fiber optic light guide including a fiber optic bundle of individual optical fibers arranged in a randomized, blended pattern with a small portion of the fibers being braided into a separated divergent bundle near the distal end of the light guide. In this embodiment, the majority of the fibers direct light along the general length of the light guide from the light source to a desired location. A relatively small number of fibers are arranged at an angle different from the general direction of the fiber optic bundle. This divergent bundle of fibers transmits light from the light source to a measuring means as mentioned above and as described below.

The feedback control loop may comprise any means for maintaining a quantity of light received from the light source at a desired level. In one embodiment, the feedback control loop comprises means 720 for measuring the amount of light or other electromagnetic radiation emitted by the electromagnetic radiation source in real time, and a controller 730. The means 720 for measuring the amount of light emitted by the electromagnetic radiation source 710 in real time may comprise one or more devices capable of measuring the quantity of light in a beam. Illustrative devices include but are not limited to photodiodes, photo-detectors, phototransistors, photoresistors, light-to-analog light sensors, light to digital light sensors and light-to-frequency light sensors. In one embodiment, the device generates a signal that is proportional to the amount of light detected. In an alternate embodiment, the means for measuring is at least one light-to-frequency light sensor. The measuring means 720 may be located anywhere along the path of light from the light source 710 to the desired location 740 that is to be cured. The measuring means can be located distal to the light source; such a measuring means may, for example, be located near the distal end of the light transmitting member, as is the case with the measuring means formed by the light quantity sensor assemblies 300 and 500 of FIGS. 11-13. In an alternate embodiment, the measuring means may be located distal to a divergent bundle of optical fibers, as is the case with the measuring means formed by the light quantity sensor assembly 200 of FIG. 8.

The controller 730 may include at least one device known in the art that is capable of receiving a signal generated from the measuring means 720, comparing the received signal to a set point, and causing the quantity of light emitted by the light source to increase, decrease, or remain constant. Exemplary devices include microprocessors and microcontrollers. The storage means may comprise at least one device that is capable of receiving data from an input means, storing the data, and allowing the data to be used in calculations. Exemplary devices include volatile and non-volatile, internal and external memory devices. In addition to allowing a user to input data, the user input/display device 700 may also comprise any device that is capable of visually communicating information to a user. Exemplary devices include analog dials, digital displays, liquid crystal displays, LED and OLED displays, plasma displays, CRT displays, incandescent light displays and the like. The display may be separate or integral with the input means. In one embodiment, the display is at least one touch screen that is also used as the input means. Touch screens are well known in the art of dental curing systems and other arts and, therefore, an extensive description is not included here.

A dental light curing system of the present invention provides a user with a higher quality, more efficient cure of a dental composite. As is well known in the art and as is described with respect to the BISCO BISCOVER product above, each light curable material requires a certain amount of light energy per unit area in order to obtain a desired cure. Therefore, if the quantity of the light transmitted to the light curable material is known, then the desired cure time can be easily calculated. The dental light curing system of one embodiment of the present invention ensures that an essentially constant, known quantity of light is transmitted to a light curable material during each curing process. The system utilizes real time feedback control to maintain that essentially constant quantity.

The dental light system operates in the following manner. A user selects or enters a desired quantity of light by way of the user input/display device 700. For example, assuming the system is to be used as a dental curing system, the user may enter a quantity of light, such as irradiance, that is recommended by the light curable material manufacturer. The user input light quantity is then stored in the storage means. The user then initiates the light curing system. This initiation can occur by any means using the input means such as pressing a “START” button or icon. The initiation of the system causes the light source 710 to emit light. The light travels from the light source 710 to the light transmitting member and through the light transmitting member to the desired location 740. The feedback control loop ensures that the quantity of the light received from the light source is equal to the user input light quantity.

In one embodiment of the present invention, the feedback control loop operates in the following manner. Light is transmitted from the light source 710 to the desired location 740 to be cured. The light is measured somewhere along this path by the light measuring device 720. The light measuring device 720 then sends a signal, representing, for example, the intensity or power density of the light, to the controller 730. The controller 730 compares the signal to a user input intensity. The controller 730 then communicates with the power supply 705, which adjusts the power of the light source 710 if the measured intensity is different from the user input intensity. For example, if the measured intensity is less than the user input intensity, then the controller 730 communicates with the power supply so that it will increase the output of the light source 710. The power of the light source 710 can be adjusted by any method known in the art of variable power light sources. For example, the current or voltage provided to the light source could be adjusted or the resistance of the light source could be changed. Of course, a combination of these actions or any other method that causes the intensity of light generated by the light source to change could be used. In one embodiment, the power of the light source is adjusted by changing the current supplied to the light source. For example, if the measured intensity is less than the user input intensity, then the controller will increase the current supplied to the light source. The feedback control loop operates in a continuous manner. Thus, at any time t, the measured intensity of the light I_{M}(t) is compared to the user input intensity set point I_{SP}. The power of the light source P(t) is then adjusted to bring I_{M}(t) closer to I_{SP}. Thus, the controller will perform one of the following actions at any time t:

if I_{M}(t)<I_{SP}, then controller increases P(t);

if I_{M}(t)>I_{SP}, then controller decreases P(t);

if I_{M}(t)=I_{SP}, then controller does not adjust P(t).

As described above, in one embodiment of a dental light curing system of the present invention, the quantity of the light measured is the intensity measured at the distal end of the divergent fiber bundle of a fiber optic light guide. This embodiment is beneficial because the intensity of the light actually transmitted to the desired light curable material is the intensity of light that can most accurately be used to determine desired curing time. Therefore, the closer the measurement can be made to the light curable material, the more accurate the curing time calculation. The use of the divergent fiber bundle allows the intensity of the light to be measured near the location to be cured but not create any interference with the curing process. Of course the light could also be measured at any other point between the light source and the location to be cured. The intensity of the light could also be measured at multiple locations. The light guide is not limited to a fiber bundle, however, and could be composed of a light transmitting element or light transmitting elements of any appropriate sort, such as single or multiple clad or unclad optical conductors.

The dental light system of the present invention ensures that a desired quantity of light is transmitted, for example to a light curable material. Thus, a curing system can accurately determine when a particular material is fully cured if a user inputs the light quantity that is required to achieve clinically acceptable polymerization, such as an optimal energy density or EOP (energy of optimization of polymerization). The user, for example, could enter the EOP value for a given light curable material using the input means. For example, the user could enter a number and then choose the appropriate units. Alternatively, the light curing system could be preprogrammed with a number of EOPs for a number of different light curable materials. The EOPs could be preprogrammed by the manufacturer. A user could also program additional EOPs into the system. For example, a user could enter the EOP for each light curable material that the user uses. By preprogramming the EOPs, a user could simply select a given material from a list on the input means. Of course, the desired intensity for a given material could also be preprogrammed at the factory or by a user. Thus, by a user simply selecting a light curable material from a list, the user could select an EOP and a user input intensity in a single step. Any method of input means could be used in the light curing system, including voice recognition software. Therefore, by simply saying “BISCOVER,” for instance, the light curing system could be set to operate at an intensity of 500 mW/cm² and an EOP of 7,500 mJ/cm².

The light curing system can then calculate the desired curing time by dividing the EOP by the user input intensity. For example, for BISCOVER, the light curing system would calculate an desired cure time of 15 seconds. In one embodiment of the light curing system of the present invention, the light source automatically shuts off after the desired cure time is reached. Of course, the desired cure time could also be determined by measuring the actual intensity of the light transmitted by the light curing system. For example, at any time t, the total amount of the energy per unit area transmitted by the light source E_{T}(t) could be calculated by taking the integral of I_{M}(t).

E_{T}⁽t)=∫I_{M}(t)dt

In this embodiment, when the calculated E_{T}(t) is equal to the EOP for the selected material, the light source would automatically shut off. As opposed to shutting off when the EOP is reached, the light curing system could simply signal to the user that the EOP has been reached. For example, the light curing system could issue an audible, visual, tactile signal, or a combination thereof to inform the user that the EOP has been reached.

In use, in this example, the controller receives a signal from the measuring means, compares the measured intensity to the intensity set point, and adjusts the intensity of the light source in order to bring the measured intensity closer to the intensity set point.

As an alternative, as alternatives to, or in addition to real time optical regulation of light emitted by a light source as described, regulation according to the invention could also include power sensing regulation, voltage sensing regulation, or another type of regulation that does not use light sensing regulation.

The foregoing disclosure has been set forth merely to illustrate the invention and is not to be considered limiting. Since modifications to the disclosed embodiments incorporating the spirit and substance of the invention may occur to persons of ordinary skill in the art, the invention should be construed to include everything within the scope of the appended claims and equivalents thereof.

1. A light quantity regulation system for dentistry comprising:
a light source;
a power supply that adjusts a quantity of light produced by the light source;
a measuring device that measures a quantity of light received from the light source;
an input, through which user data, including a desired quantity of light, can be entered by a user; and
a controller that, together with the measuring device, forms at least part of a feedback loop, the controller communicating with the power supply and the measuring device and receiving the user data;
wherein said power supply adjusts a quantity of light emitted by the light source based on communication provided by the controller so that the quantity of light received from the light source becomes substantially equal to said desired quantity of light.

2. The system of claim 1, wherein the light quantity regulation system is a dental light curing system.

3. The system of claim 1, wherein said measuring device is disposed in the light transmission path of the light source.

4. The system of claim 1, wherein said measuring device is disposed in the light transmission path or is one of a plurality of measuring devices disposed in the light transmission path.

5. The system of claim 1, wherein said light source is at least one of a halogen light source, a xenon light source, a LED light source, a LED emitter light source, a LED die light source, a LED array light source, a metal halide light source, a mercury vapor light source, a sodium light source, and a laser light source.

6. The system of claim 5, wherein said light source is one of a plurality of light sources.

7. The system of claim 1, wherein said measuring device is selected from a photodiode, a photodetector, a phototransistor, a photoresistor, a light-to-analog light sensor, a light-to-digital light sensor, a light-to-frequency light sensor, and combinations thereof.

8. The system of claim 7, wherein said measuring device is one of a plurality of measuring devices.

9. The system of claim 1, further comprising a hand held curing unit that is held by hand during curing procedures.

10. The system of claim 9, further comprising a light guide passing light received from the light source to the hand held curing unit.

11. The system of claim 9, further comprising a housing, containing at least the light source, adapted to receive an end of the light guide.

12. The system of claim 9, further comprising a lens or cover assembly disposed at a distal end of the hand held curing unit.

13. The system of claim 12, wherein the lens or cover assembly is disposed at a distal side of the light source.

14. The system of claim 1, wherein at least one of the light source and the controller is powered by alternating current.

15. The system of claim 1, wherein at least one of the light source and the controller is powered by direct current.

16. A hand held light quantity regulation system according to claim 1.

17. A cordless hand held light quantity regulation system according to claim 1.

18. The cordless hand held system of claim 17, wherein at least one of the light source and the controller is powered by direct current, is attached to an alternating current/direct current converter, or is attached to a direct current/alternating current converter.

19. The system of claim 1, wherein the controller includes at least one control device adapted to receive input from the light measuring device, perform a comparison of the input received from the light measuring device and a set point, and adjust power supplied by the power supply to the light source based on the comparison.

20. The system of claim 19, wherein the set point is a quantity of light.

21. The system of claim 19, wherein the control device is a microprocessor or a microcontroller.

22. The system of claim 4, wherein at least one of the measuring devices is selected from a photodiode, a photodetector, a phototransistor, a photoresistor, a light-to-analog light sensor, a light-to-digital light sensor, a light-to-frequency light sensor, and combinations thereof.

23. The system of claim 10, wherein the light guide includes one or more light transmitting elements comprising single or multiple clad or unclad optical conductors providing light transmission.

24. The system of claim 23, wherein some of the light transmitting elements are bifurcated into a separate bundle leading to the measuring device.

25. The system of claim 1, wherein the controller communicates with the power supply so that said quantity of light emitted by the light source is adjusted by analog voltage regulation, analog current regulation, pulse with modulated voltage, pulse width modulated current, or a digital signal.

26. The system of claim 16, wherein the controller communicates with the power supply so that said quantity of light emitted by the light source is adjusted by analog voltage regulation, analog current regulation, pulse width modulated voltage, pulse width modulated current, or a digital signal.

27. The system of claim 10, wherein the light guide is substantially rigid.

28. The system of claim 10, wherein the light guide is flexible.

29. A process using a real time, optically regulated dental unit comprising:
supplying a quantity of light by way of a light source;
receiving data, including a desired light quantity, entered by a user;
measuring a light quantity received from the light source;
performing a comparison of the desired light quantity with the light quantity received from the light source; and
adjusting the quantity of light supplied by way of the light source based on said comparison.

30. The process of claim 29, wherein the process is a process of curing a composite dental resin, and the quantity of light is supplied to said resin.

31. The process of claim 29, wherein the light quantity received from the light source is received by one measuring device or a plurality of measuring devices disposed along the light transmission path and placed directly in the light transmission path or in proximity to the light transmission path so that a quantity of transient or reflected light is received.

32. The process of claim 31, wherein the quantity of light supplied by the light source is increased as a distance between the dental resin and the light source increases.

33. A process of compensating for effects on how a real time, optically regulated dental unit is held by a user comprising:
supplying a quantity of light by way of a light source;
receiving data, including a desired light quantity, entered by a user;
measuring a light quantity received from the light source;
performing a comparison of the desired light quantity with the light quantity received from the light source; and
adjusting the quantity of light supplied by way of the light source based on said comparison.

34. The process of claim 33, wherein the dental unit operates to cure a composite dental resin, and the quantity of light is supplied to said resin.

35. The process of claim 34, wherein the quantity of light supplied by the light source is increased as a distance between the dental resin and the light source increases.
